(19) United States
(12) Patent Application Publication
(10) Pub. No.: US 2004/0059830 A1
(43) Pub. Date: Mar. 25, 2004

(54) Network address space clustering employing topological groupings, distance measurements and structural generalization

(75) Inventor: Geoffrey M. Brown, Bloomington, IN (US)

Correspondence Address: WEINGARTEN, SCHURGIN, GAGNEBIN & LEBOVICI LLP, TEN POST OFFICE SQUARE, BOSTON, MA, 02109, US

(73) Assignee: SOCKEYE NETWORKS, INC.

(21) Appl. No.: 10/662,108

(22) Filed: Sep. 12, 2003

Related U.S. Application Data
(60) Provisional application No. 60/411,404, filed on Sep. 17, 2002.

(51) Int. Cl. G06F 15/173

(52) U.S. Cl. 709/238

(57) ABSTRACT

A method for clustering the Internet address space employs structural, topological, and temporal clustering techniques. Seedpoints are identified from among network destinations; the seedpoints are topologically clustered into groups; temporal measurements from one or more predetermined locations are made to a seedpoint in each group; and the seedpoints are clustered based on the measurements. The clusters are generalized based on information identifying the network addresses with seedpoints deemed to be close, such as address prefixes in a routing table. A representative is selected for each cluster, such as an intermediate node on a path shared by the seedpoints of the cluster. The technique can be employed by different types of applications, including route selection in an intelligent route controller.

### CROSS REFERENCE TO RELATED APPLICATIONS

This application claims priority under 35 U.S.C. §119(e) of U.S. Provisional Patent Application No. 60/411,404 filed Sep. 17, 2002, the disclosure of which is hereby incorporated by reference herein.

### STATEMENT REGARDING FEDERALLY SPONSORED RESEARCH OR DEVELOPMENT

--Not Applicable--

### BACKGROUND OF THE INVENTION

The present invention is related to the field of communications networks, and more specifically to techniques for creating a sub-division of a network address space for use by network applications.

It has been known to employ techniques for “clustering” network addresses for various purposes, such clustering amounting to a sub-dividing of a network address space. In a very broad sense, even the basic structure of the Internet assumes that sources and destinations are grouped into “subnetworks” for purposes of functions such as inter-subnetwork routing. Generally, any kind of clustering enables applications and protocols to deal with single entities that each represent a group of objects, rather than having to deal with a large number of objects individually. This feature improves efficiency in some network operations, and may be essential in enabling other operations.

There are different types of clustering techniques that have been used to facilitate or improve operations within the Internet. These includes three specific techniques that are described in some detail: structural clustering, topological clustering, and temporal clustering.

In structural clustering, routing tables used by a network routing protocol, such as the Border Gateway Protocol (BGP), provide natural clusters with two levels of granularity—autonomous systems (AS's) and address prefixes. While utilizing such clustering has the advantage of simplicity and economy, there are nonetheless some deficiencies with this approach. The two granularities are essentially fixed, and may be either too coarse or too fine depending upon the application. Even with the finer granularity level of prefixes, there may not be as much uniformity among nodes sharing a prefix as might be expected. For example, prefixes exist that span the entire United States. Additionally, there may be groups of addresses in different prefixes that would be advantageous to cluster together, but the BGP routing tables provide no mechanism for doing so.

Topological clustering uses information that is inferred from tracing paths within the network. In the Internet, these commonly take the form of “traceroutes” from various sources to a wide number of destinations. Two destinations are considered to be “near” if traceroutes to them intersect at common points within a few hops of the destination. The most significant failing of the topological approach is that there is no natural way to vary the clustering granularity, because the requirements for adjacency are so strong. Hops in the sense of traceroutes really correspond to interfaces on a router. Two traceroutes can traverse the same router but not the same interface, and the traceroutes will not be considered to merge at the common router. Also, two traceroutes to destinations in the same geographical region may traverse routers that are in the same point of presence (POP) and yet never go through the same routers. Often, for a single destination, no common hop is found from multiple traceroutes, and destinations that are near each other both geographically and topologically are considered distinct and therefore will not be clustered together.

Topological techniques also tend to suffer coverage problems. Even after the results of topological tracing are expanded or generalized to other network nodes in some intelligent manner, large regions of the Internet address space fall into no cluster. The coverage problem for traceroute-based techniques arises because two regions can only be considered adjacent if they share a common hop. If no common hop exists, then there is no distinguishing information—it cannot be determined whether two regions are relatively close or relatively far from each other. Thus the “shared hop” relationship is a strong but rather sparse equivalence relationship.

Temporal clustering utilizes measurements of time delays between a set of S servers and a number of destinations. These measurements may be gathered actively by sending probes (e.g. pings) to the destinations, or passively by monitoring traffic (e.g. the intervals between messages and their acknowledgments in the Transmission Control Protocol (TCP)). The result of these measurements is an S-dimensional distance vector for each destination, where the delay values represent temporal “distance”. These distance vectors provide a convenient basis for determining whether two destinations are near, such as by performing Euclidean distance determinations. Clustering may be performed in a number of ways including subdividing the BGP prefixes until all “fractional prefix” clusters contain destinations meeting some distance requirement. Alternatively, the distance vectors could be used to estimate the physical distance of each destination from a set of known reference points and clusters built in relationship with these reference points. One of the significant shortcomings of temporal clustering techniques is the large volume of measurement that is done, requiring an undesirably high volume of network traffic. Also, information is obtained about only those destinations which are actually measured, resulting in undesirably sparse coverage.

### BRIEF SUMMARY OF THE INVENTION

In accordance with the present invention, a clustering method is disclosed that overcomes the above-discussed shortcomings of known clustering techniques.

In the disclosed technique, a number of seedpoints are selected from among a generally much larger number of network destinations. Each seedpoint is active in the sense of responding to probes, and is associated with at least one group of network addresses, such as defined by address prefixes stored in a routing table.

The seedpoints are topologically clustered into groups of topologically similar seedpoints, to reduce the number of subsequent measurements that are required.

Measurements are then performed from one or more predetermined locations to a seedpoint within each group of seedpoints. In the illustrated embodiment, these measurements take the form of probes that yield round-trip delay times.

The seedpoints are then clustered based on the measurements. One feature of the clustering is the ability to achieve a desired trade-off between the number of clusters and the similarity among the measurements for the seedpoints within each cluster. This feature results in a desired balance between cluster accuracy (i.e., how representative the group of seedpoints is of each individual seedpoint) and the amount of computing resources required to establish, maintain, and utilize the set of clusters.

The clusters are then generalized based on the information indicating which seedpoints are close to others. This information can include the address prefixes in a routing table. Generalizing generally includes conditionally modifying the set of address prefixes, such that each address prefix is associated with only one cluster. In general, each cluster may be associated with multiple address prefixes.

Once the clustering is done, it is generally desired to select one or more representatives for each cluster that will participate in the application or protocol for which the clustering has been done. The selected representative(s) have some predetermined relationship to the seedpoints of the cluster, such as being near a “centroid” (mean or median point) of the cluster in terms of the measurements, or lying along a path to the centroid or some other point. The representative is then associated with each address prefix that is associated with the cluster set of address prefixes.

The technique supports variable cluster granularity with the option to use finer granularity for some regions of the network address space if desired, for example if such regions exhibit greater structural complexity or have a relatively large share of the overall traffic. While the clustering is primarily based upon the distance measurements, topological clustering is also utilized to reduce the amount of measurement required, by enabling the use of only a subset of the seedpoints for measurement. This yields greater efficiency. Structural clustering is used to generalize the results to larger address blocks.

Additionally, the seedpoints of a cluster can be ordered by their proximity to the cluster center, providing a mechanism to determine the most representative points for utilization by an application, such as an intelligent route control system.

Other aspects, features, and advantages of the present invention will be apparent from the Detailed Description of the Invention that follows.

### BRIEF DESCRIPTION OF THE SEVERAL VIEWS OF THE DRAWING

The invention will be more fully understood by reference to the following Detailed Description of the Invention in conjunction with the Drawing, of which:

FIG. 1 is a block diagram of a network employing a clustering technique in accordance with the present invention;

FIG. 2 is a flow diagram of the clustering technique employed in the network of FIG. 1;

FIG. 3 is a diagram depicting a set of temporal measurements from a set of sources to a set of destinations in the clustering technique of FIG. 2; and

FIG. 4 is a graph illustrating an example of results of the clustering process of FIG. 2.

### DETAILED DESCRIPTION OF THE INVENTION

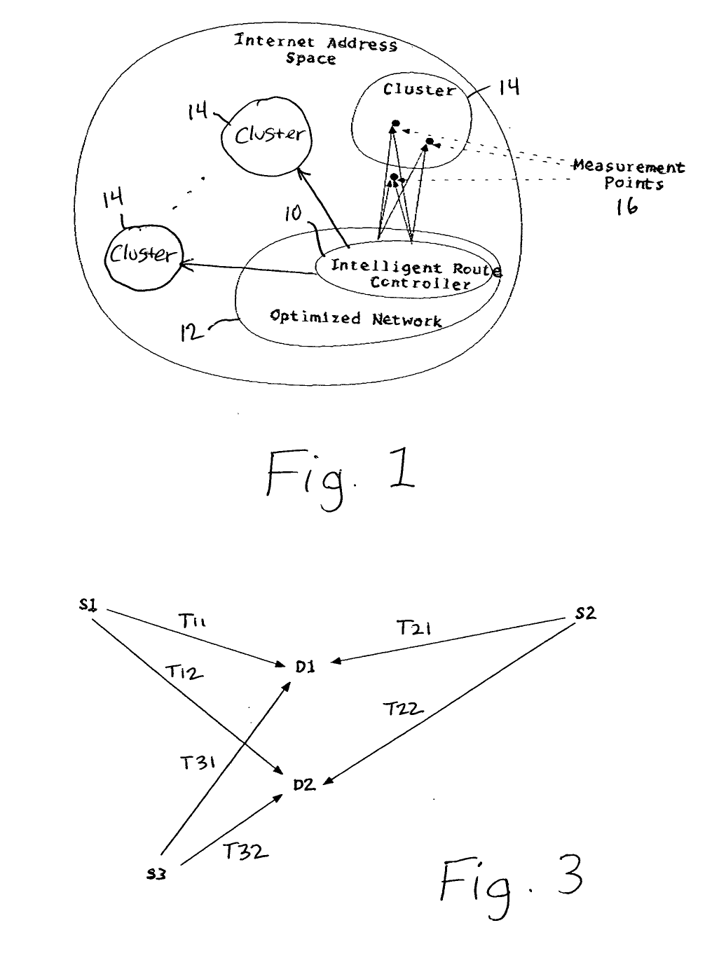

A technique is described for clustering the Internet address space for purposes of performance measurement. The technique can be used to support a variety of applications such as intelligent route control, which is illustrated in FIG. 1. An intelligent route controller 10 optimizes traffic sent from an optimized network 12 (which is a subset of the Internet (IP) address space) to destinations within a set of non-overlapping regions 14 called clusters. Each cluster 14 has a set of associated measurement points (or scanpoints) 16 which may be (but are not necessarily) identified by IP addresses within the cluster. To make routing decisions for traffic from the optimized network 12 to a cluster 14, the route controller 10 performs a series of measurements to the scanpoints 16 of the cluster over multiple connections that the optimized network 12 has to the Internet. Depending upon the results of these measurements, the route controller 10 can cause local router(s) (not shown) to prefer one of the Internet connections over the others for traffic destined for the cluster.

From the perspective of the route controller 10, a cluster 14 can be viewed as an equivalence class, and the scanpoints 16 as proxies for the members of that class. It is assumed that the expected performance of traffic to destinations within a given cluster 14 over a given Internet connection will be equivalent for all possible destinations. This assumption is referred to herein as the “uniformity assumption.” There is generally a trade-off between the accuracy of the uniformity assumption and the amount of measurement that must be performed. In particular, the desired accuracy of the uniformity assumption may vary in different clusters 14 depending upon factors such as (1) the fraction of traffic from the optimized network 12 to the cluster, and (2) the geographical distance from the optimized network 10 to the cluster.

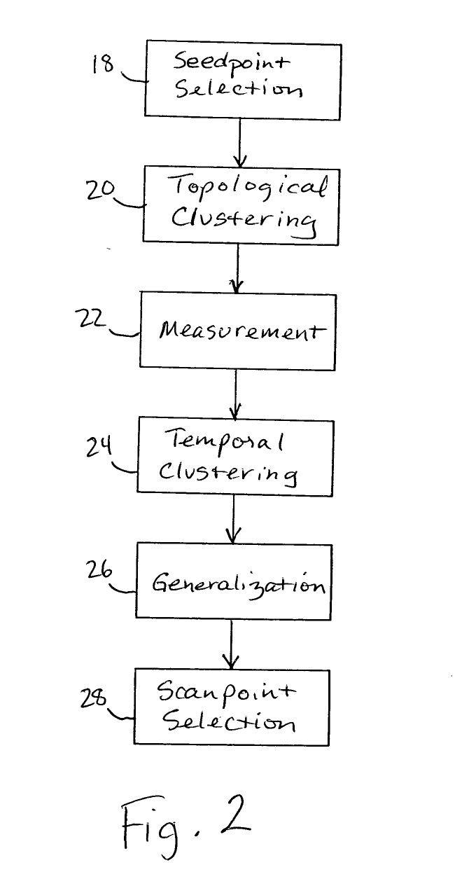

As shown in FIG. 2, there are six major steps employed in the overall clustering process: seedpoint selection 18, topological clustering 20, measurement 22, temporal clustering 24, generalization 26, and scanpoint selection 28. Each of these sub-processes is described in turn below.

Seedpoint Selection 18

The goal of seedpoint selection is to select a set of representative addresses (termed “seedpoints”) from the routable IP address space that respond to probe messages used for temporal measurements. An important consideration is the finest address granularity required. For example, most routes in a BGP routing table cover at least 256 addresses (/8 . . . /24 prefixes). Granularity finer than /24 is generally not useful for purposes of intelligent route control. In the following description, a granularity of /24 is assumed. In alternative embodiments, it may be desirable to employ more or less address granularity.

In one basic approach, seedpoints can be collected from traffic statistics. This approach may be preferable in applications such as that shown in FIG. 1, in which the intelligent route controller 10 is placed at a customer site and can therefore collect traffic statistics for the optimized network 12 relatively easily. For example, traffic data can be collected that permit the identification of all of the active /24 prefixes (each defining a region of 256 addresses differing only in their 8 least significant bits) in the Internet traffic emanating from the optimized network 12. Then, to select corresponding seedpoints for these prefixes, one strategy is to search for an active endpoint in each prefix. Alternatively, representative seedpoints can be harvested from web logs or other traffic statistics. It may also be desirable to vary the density of the seedpoints in the various address prefixes based upon traffic statistics.

Seedpoint selection can also be performed using “brute force” techniques. There are currently roughly 4.7 million routable /24 prefixes in a typical BGP routing table. It has been demonstrated experimentally that testing a particular sequence of 11 destinations within an active /24 prefix has a 90% chance of finding at least one live endpoint. Thus, roughly 50 million addresses must be tested to find seedpoints in a high fraction of the active /24 address blocks in a typical BGP routing table.

Topological Clustering 20

Many of the seedpoints generated during seedpoint selection 18 can be shown to be equivalent using topological probing techniques, for example by performing “traceroute” operations from one or more sources to each seedpoint. Seedpoints that are determined to be topologically close are deemed to be equivalent. Only one representative from each equivalence class of seedpoints needs to be selected for use in temporal measurement 22 (described below). A criteria for topological closeness might sharing the same final hop, for example. As described in an example below, even a simple heuristic results in a 4:1 reduction in the amount of measurement required.

It would be possible to use the topologically clustered seedpoints themselves as the scanpoints for use by the ultimate application, such as intelligent route control. However, as mentioned previously, topological clustering has the deficiency of being too fine grained. Thus, the results of topological clustering are coarsened using additional processes including temporal clustering as described below.

Measurement 22

A plurality of measurements of round trip times to each seedpoint are taken. There are a number of techniques that can be used, such as measuring the Internet Control Message Protocol (ICMP) echo request/response period with a “ping” tool; measuring the time to establish a TCP connection; or using a time-to-live (TTL) limited probe sent to the seedpoint with a TTL smaller than required to reach the destination.

Temporal Clustering 24

The round trip time measurements are then clustered using any of a variety of data clustering techniques, including divisive and agglomerative hierarchical techniques and iterative techniques such as Kmeans. The general strategy of temporal clustering is to associate each seedpoint with the data obtained by measuring the latency to the seedpoint (or to a proxy scanpoint) from either a single point (such as the intelligent route controller 10) or multiple measurement “servers” (not shown in the Figures). Seedpoints that have similar measurements are considered to be equivalent. An example is given with respect to FIG. 3. If measurements are made from three servers S1, S2, and S3 to destinations D1 and D2, two sets of “coordinates” are obtained: (T11, T21, T31), (T12, T22, T32). The Euclidean distance between the destinations D1 and D2 can be computed using the formula:

$${distance}_{12} = {( {\sum }_{i = 1}^{3} {\vert {T}_{i1} - {T}_{i2} \vert}^{2} )}^{1 / 2}$$

Other distance metrics such as Manhattan distance can be employed.

As an example, measurements have been taken from four servers located in Seattle, San Jose, Boston, and Atlanta, to a set of 806 proxy scanpoints associated with a particular Autonomous System known as AS3356, which is associated with the company Level 3 Communications, Inc. These scanpoints were generated using a process described in more detail below. Briefly, seedpoints were first selected, then representative seedpoints were selected from these based upon topological clustering, and proxy scanpoints were then chosen that lay “in front” of these representatives based upon traceroute operations. From these 806 scanpoints, 25 were randomly selected for this example.

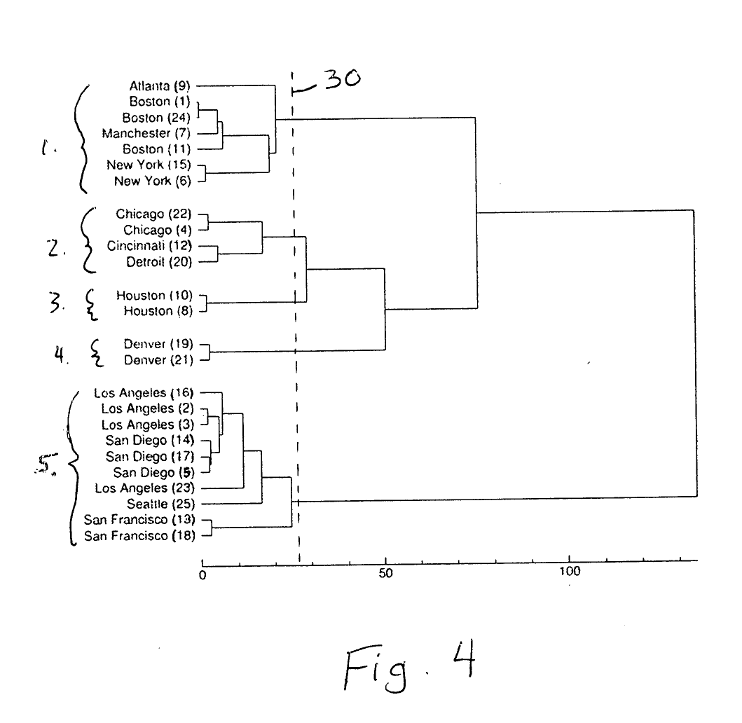

Using a set of known tools implementing standard agglomerative hierarchical clustering algorithms, the 25 points were clustered into five groups. The particular algorithm used was “complete link” with Euclidean distance. Complete Link clustering determines the “similarity” of two clusters based upon the distance between the most distant members. FIG. 4 is a dendrograph showing the results of this example clustering process. The dendrograph lists the scanpoint locations (as determined through Domain Name Service (DNS) lookups and traceroutes) on the left. The numbers in parenthesis are provided in place of IP addresses for clarity. At the bottom is a time scale in milliseconds. The lines represent the results of combining scanpoints or sub-clusters into larger clusters. The location of each vertical line represents the maximum Euclidean distance (temporally) between the two farthest-separated members of the cluster spanned by the line. Scanpoints and sub-clusters are recursively combined until a single cluster is reached at the far right. Thus, the members of cluster 1, for example, are separated by no more than about 20 milliseconds. In contrast, there is at least one pair of points from clusters 1 and 4, for example, that are separated by about 70 milliseconds.

FIG. 4 clearly shows the trade-off between the number of clusters and the “similarity” of the members. If clusters are chosen near the left edge of the dendrograph, there tends to be greater similarity (i.e., less delay difference) among the members of a cluster, but there are also a relatively large number of clusters. If clusters are chosen nearer the right edge, the number of clusters diminishes, but so does internal cluster similarity. The dotted line 30 represents a selection of 5 clusters with a maximum intra-cluster distance of about 25 ms. In this example, limiting the results to 5 clusters results in clusters covering relatively large geographic regions, such as the region between Atlanta and Boston.

From the clustering process, an ordered list of the scanpoints used to generate each cluster can be generated. These scanpoints can be ranked by distance to the cluster centroid (mean or median). This ordering provides a mechanism for choosing the most representative point(s) in each cluster for use as may be needed. The intelligent route control application, for example, performs periodic temporal measurements to a representative point to make routing decisions for all destinations in the cluster. For the example illustrated in FIG. 4, the scanpoints nearest the centroid of each cluster are:

Cluster 1: Boston (11)

Cluster 2: Detroit (20)

Cluster 3: Houston (10)

Cluster 4: Denver (19)

Cluster 5: Los Angeles (2)

Generalization 26

The goal of the generalization phase is to expand the clustering results which generated equivalence classes containing specific IP addresses (i.e. the seedpoints) into equivalence classes containing blocks of IP addresses. The generalization phase combines the clustering information from the topological and temporal clustering with structural information obtained from a set of routing tables such as BGP routing tables.

A prefix table is formed by aggregating multiple BGP tables, and this prefix table is used to perform structural generalization of each cluster of seedpoints. This process may be performed either top-down or bottom-up. In the top-down process, each seedpoint is assigned to the longest matching prefix from the table. If seedpoints in different clusters are assigned to a prefix, the prefix is divided into two more-specific prefixes, and the seedpoints are reassigned to the longest matching of the new prefixes. This process continues until no prefix has been assigned seedpoints from multiple clusters.

As an example, consider generalization of seedpoints in conjunction with a BGP prefix as illustrated below:

| | | |
|---|---|---|
| Seedpoints: | 63.200.1.1 | (Cluster X) |
| | 63.200.2.1 | (Cluster X) |
| | 63.200.128.1 | (Cluster Y) |
| Initial prefix: | 63.200.0.0/16 | |

The prefix is split into the following two new prefixes:

63.200.0.0/17

63.200.128.0/17

It will be seen that the two seedpoints (from cluster X) can be assigned to the first of these new prefixes, and the seedpoint from cluster Y can be assigned to the second. In this case, the process ends after only one iteration. If seedpoints from multiple clusters were still assigned to one or more of the new prefixes, then the process would be repeated for each such prefix, etc., until each prefix was assigned seedpoints from only one cluster.

The bottom-up approach begins by assigning each seedpoint to its corresponding /32 prefix. The process proceeds by merging adjacent prefixes that contain seedpoints from at most one cluster. The merging process forbids merging across BGP prefix boundaries and terminates when no more merges are permitted.

Scanpoint Selection 28

The clustering step 24 provides for each cluster list of seedpoints ranked by distance from the cluster centroid. To find a scanpoint for a given seedpoint over a particular Internet connection, a traceroute is performed to the seedpoint over the Internet connection. A scanpoint is then selected from one of the traceroute hops. This technique provides the opportunity to generate multiple scanpoints for important clusters and to generate backup scanpoints in case some scanpoints cease responding to measurement probes.

The clustering and scanpoint selection process described above may be utilized in standalone applications or in distributed applications. An example of a standalone application is a single intelligent route controller 10 responsible for all aspects of intelligent routing, including the selection of scanpoints and measuring path delays to improve routing performance. An example of a distributed application is a system employing a number of intelligent route controllers 10 at different locations. In such systems, it may be beneficial to perform the seedpoint selection 18 using a centralized process and then provide the list of seedpoints to each intelligent route controller 10, which then performs the measuring 20 and subsequent steps. By performing the measuring step 20 and subsequent steps at each intelligent route controller 10, the temporal measurements made at each intelligent route controller 10 should more accurately reflect the actual delays that are experienced by traffic emanating from the associated optimized network 12. Alternatively, these later steps can also be performed using the centralized process, which might be advantageous if processing resources at each distributed location are scarce. In such an embodiment, at least some of the temporal measurements may be less predictive of the actual delays that will be experienced from any particular optimized network 12, because the measurements have been taken from locations other than the sources of the traffic being optimized. It may be desirable to share measurement results among a distributed set of route controllers. Alternatively, the work can be partitioned between the central facility and the route controllers at any of steps 24-28 of FIG. 2.

Details of Particular Embodiments

In one embodiment, one seedpoint is identified for each active addressable /24 route in a set of BGP routing tables, with the exception of regions containing .gov or .mil domains (such domains have a policy of discouraging the external probing that is necessary to perform temporal measurement). In practice, only a fraction of the /24s in a routing table contain active endpoints. The seedpoint selection process consists of searching for an endpoint in each /24 that responds to ping requests. Experience suggests that the .1 addresses in roughly 50% of active /24s respond to ping requests. It has also been suggested to search a particular sequence of 11 addresses within an active /24 in order to find a live endpoint. A subset of such addresses such as (.1,.129,.254, .2) may also be employed.

An important step in the disclosed process is the use of topological clustering techniques to reduce the amount of temporal measurement required. A single traceroute is performed to each seedpoint from a single source. The endpoints of traceroutes that contain the same penultimate hop are deemed to be to equivalent. Alternatively, two endpoints may be treated as equivalent if they are within some temporal distance of a common hop.

In one embodiment, the penultimate hop on the traceroute to each seedpoint (performed in the topological clustering phase) is selected as a measurement point (scanpoint) 16. Because of issues relating to multi-homing, scanpoints that are not in the same AS as their corresponding seedpoint are rejected.

In one embodiment, one ping per hour is performed to each destination from each source for 24 hours. Alternative frequencies and durations may be used. The goal is to establish a good estimate of the minimum round-trip time between each source and each scanpoint. The ping results are aggregated, and scanpoints that do not respond to ping requests in a reliable and stable manner are discarded. For each source and destination, the minimum ping response time is chosen. From these time measurements, an S-dimensional distance vector is then formed for each destination (assuming S sources). While measurements are made to scanpoints, alternative embodiments might measure directly to representative seedpoints.

As mentioned above, scanpoints that do not respond reliably to pings are discarded. It has been determined that roughly 7% of scanpoints do not respond at all to pings. Additionally, scanpoints for which there is too much temporal variation are also discarded. Some scanpoints respond reliably to pings but with excessive delay, which can result in the existence of outliers in the clustering process. This situation can be handled by finding the closest source from the ping experiments and rejecting any destinations that are farther than some maximum distance from their closest source; this threshold may differ for the various sources. For example, it may be advantageous to discard data for any scanpoint for which the ratio of 33rd percentile to minimum ping values exceeds 1.5 for any server.

As mentioned above, the disclosed embodiment performs agglomerative complete link clustering on a per AS basis. For each AS, the number of clusters to be generated is determined based upon the complexity of the AS (e.g. in terms of the fraction of unique scanpoints within that AS). Alternatively, the cluster “budget” for an AS might be based upon customer traffic statistics. The clustering budget for an AS may be defined using a heuristic such as the following: 20 clusters for each 1% of the total scanpoints in the AS, with a minimum of 1 cluster/AS. Other heuristics may be employed. Any heuristic should satisfy the measurement budget of the application (such as route optimization) and be reasonably related to the “complexity” of the ASs being clustered.

In order to eliminate outliers, each AS can be clustered twice—first with a cluster budget larger than the target budget, and then with the target budget. After the first clustering, scanpoints that fall into clusters containing too small a fraction of the scanpoint total are rejected. The remaining scanpoints are then re-clustered using the target budget. As a refinement to this process, the clustering process can be constrained to respect geographical regions. In particular, in a centralized clustering process, measurement servers can be partitioned into geographical regions and each scanpoint associated with the region of its nearest server. Only scanpoints in the same region are permitted to be placed in the same cluster. It is reasonable that in clustering a particular region, only the data from a subset of the servers is used.

The idea of using temporal measurements for clustering seems to depend upon the assumption that there is some reasonable correlation between distance and ping measurements. Experiments tending to confirm this assumption have been conducted.

Extensions/Alternatives

As mentioned above, one measurement technique utilizes ICMP echo requests to intermediate proxies. This has two deficiencies: a reasonably high fraction of nodes (e.g., about 7%) do not respond to ICMP echo requests, and it cannot be guaranteed that the paths followed by the measurement probes are coincident with the paths followed by user data packets to the corresponding seedpoints. The first deficiency leads to reduced coverage, while the second has the potential for reducing the accuracy of the measurements.

An alternative measurement process can employ TTL limited probes, which would tend to increase the proportion of good measurements. Recall that the measurements are proxies for a group of seedpoints deemed “equivalent”. Given a representative seedpoint, a server initially performs a trace route to the seedpoint in order to determine the hop count to the penultimate hop, and then performs measurements by utilizing TTL limited probes sent to the seedpoint. Some provision may be needed for detecting when the responding machine changes. One benefit of using TTL limited probes is that the probe is guaranteed to be routed using the same path as a packet to the seedpoint.

It is also a common belief that many networks filter ICMP echo request messages. For both the traceroutes and TTL limited probes, other IP message formats could be used.

It has also been found that there are many ASs for which seedpoints can be found, but no measurement point in the same AS. As mentioned above, these are preferably rejected because the AS path followed by probes to a measurement point might not match the AS path to the corresponding seedpoint. Coverage can be improved by searching for alternative seedpoints in prefixes in which the traceroute to a seedpoint does not have its penultimate hop in the same AS. With TTL limited probes, this would be a non-issue. More generally, it is believed that TTL limited probes would have a positive impact upon coverage.

Clustering can be improved by utilizing geographic knowledge to assist the clustering process and by better elimination of outlier data. As more measurement servers are added, there is some risk that the amount of “noise” in the clustering process will become unacceptable. Geographic knowledge can be used to associate scanpoints with subsets of the measurement servers. That is, the “region” in which a point resides is determined by finding the “closest” server. Clustering can then be performed on the measurement points in a region using the most appropriate subset of servers. Since RTT measurements provide an upper bound on distance, the location of a measurement point can be reasonably bounded given the time from its nearest server.

A variation of this approach is to utilize AS information to select server subsets. There are relatively few transcontinental ASs. With the decentralization of the AS registration process, the identity of the registration service (RIPE, ARIN, LACNIC, APNIC) can be used as an indicator of which server subset is appropriate. Given the technique described above, it is relatively straightforward to detect ASs which are likely to be transcontinental. The rest could be clustered with servers chosen by AS.

Outlier elimination can be improved using the “geographic” approaches described above. It is reasonable to discard measurement points that are not within some maximum distance (time) of some server. This requirement can be tightened if the set of servers is constrained based upon the AS number.

Finally, given a set of destinations with known geographic locations (e.g. web servers in various cities), the temporal locations can be determined using the same set of servers used to perform the temporal measurements for clustering. These destinations may be referred to as “mileposts.” The above clustering process provides a centroid (either mean or median) for each cluster. The cluster can be associated with the geographic location of the milepost that is nearest to the cluster centroid. Alternatively, the geographic location may be associated with the centroid of the most important subset of the cluster points, as determined by traffic data for example.

In the foregoing, the address prefixes in the BGP routing table serve the following three purposes:

a mechanism for defining cluster membership;

a guide for the clustering process to provide some constraints on what might be close (e.g., prefixes in different ASs are not considered close); and

a basis for generalization.

In alternative embodiments, these purposes may be served using different mechanisms. For example, cluster membership can be defined using alternative notation describing a set of addresses. Clustering can be guided by another type of initial partitioning or grouping of address space, and generalization can use other information indicating what addresses might be considered “near” in the absence of measurement data to the contrary.

It will be apparent to those skilled in the art that modifications to and variations of the disclosed methods and apparatus are possible without departing from the inventive concepts disclosed herein, and therefore the invention should not be viewed as limited except to the full scope and spirit of the appended claims.

What is claimed is:

1. A method of clustering a plurality of network destinations having network addresses being partitioned into groups of network addresses according to an initial grouping, comprising:
identifying a plurality of seedpoints from among the network destinations, each seedpoint being an active one of the destinations associated with at least one of the groups of network addresses;
topologically clustering the seedpoints into groups of topologically similar seedpoints;
performing a measurement from a predetermined location to a seedpoint within each group of seedpoints;
clustering the seedpoints into clusters based on the measurements, the clusters being selected in a manner achieving a desired trade-off between the number of clusters and the similarity among the measurements for the seedpoints within each cluster; and
generalizing the clusters based on information identifying the network addresses with corresponding seedpoints to which the network addresses are deemed close.

2. A method according to claim 1, wherein the seedpoints are identified based on a predetermined desired granularity.

3. A method according to claim 2, wherein the predetermined desired granularity is expressed as a number of most significant bits of the destination addresses.

4. A method according to claim 3, wherein the destination addresses are 32 bits in length, and the predetermined number of most significant bits is 24.

5. A method according to claim 1, wherein the density of the seedpoints in different groups is varied based upon traffic statistics.

6. A method according to claim 1, wherein the seedpoints are identified based on information concerning the destinations of data traffic in the network.

7. A method according to claim 1, wherein the seedpoints are identified by sending a message to at least one address in each of a complete set of address regions spanning the destination addresses, each region being defined by a corresponding unique pattern of most significant address bits.

8. A method according to claim 7, wherein the one address in each of the address regions is one of a set of predetermined addresses within each region to which messages are conditionally sent to identify seedpoints.

9. A method according to claim 1, wherein the seedpoints are included in autonomous systems, and further comprising selecting a representative for each cluster of seedpoints, the selecting of a representative including determining whether the representative has the same penultimate hop along a path to the autonomous system as do the seedpoints of the cluster.

10. A method according to claim 9, wherein identifying seedpoints includes rejecting those seedpoints for which there is no available representative in the same autonomous system.

11. A method according to claim 1, wherein topologically clustering comprises performing traceroute operations to the seedpoints and analyzing the resulting reported routes.

12. A method according to claim 1, wherein the measurement performed from the predetermined location to each of the seedpoints is one of multiple measurements performed from the predetermined location to each of the seedpoints.

13. A method according to claim 1, wherein the predetermined location is one of multiple predetermined locations from which measurements to the seedpoints are performed.

14. A method according to claim 1, wherein performing each measurement comprises sending a time-to-live-limited probe message to a candidate seedpoint.

15. A method according to claim 1, wherein performing each measurement comprises sending an echo request message to a candidate seedpoint.

16. A method according to claim 1, wherein the measurements are temporal measurements.

17. A method according to claim 1, wherein clustering the seedpoints includes ordering the seedpoints according to the measurement.

18. A method according to claim 17, further comprising, for each cluster of ordered seedpoints, identifying at least one of the seedpoints whose measurement satisfies a predetermined criterion.

19. A method according to claim 18, wherein the predetermined criterion is being closest to a centroid of the measurements of the seedpoints.

20. A method according to claim 1, wherein clustering the seedpoints is performed on the basis of autonomous systems in which the seedpoints reside.

21. A method according to claim 20, wherein a minimum of one cluster is established per autonomous system.

22. A method according to claim 1, wherein clustering the seedpoints is performed on the basis of traffic to the network destinations.

23. A method according to claim 1, wherein clustering the seedpoints is performed in at least two passes, a first pass resulting in more clusters than desired, a second pass being based on a subset of the seedpoints taken from larger ones of the clusters resulting from the first pass.

24. A method according to claim 1, wherein clustering the seedpoints is based on geographical information about the seedpoints.

25. A method according to claim 1, wherein clustering the seedpoints employs a clustering budget of a predetermined number of clusters for each of a predetermined fraction of the total number of seedpoints.

26. A method according to claim 1, wherein the clusters are non-overlapping.

27. A method according to claim 1, wherein generalizing the clusters results in associating multiple groups of network addresses with each of at least some of the clusters.

28. A method according to claim 1, further comprising for each cluster, selecting a representative having a predetermined relationship to the seedpoints of the cluster, and associating the representative with each group of network addresses associated with the cluster.

29. A method according to claim 28, wherein the predetermined relationship of each representative to the seedpoints of the associated cluster is a predetermined relationship of the representative to a centroid of the seedpoints.

30. A method according to claim 28, wherein the predetermined relationship of each representative to the seedpoints of the associated cluster comprises lying along a network path to a selected one of the seedpoints.

31. A method according to claim 28, wherein selecting a representative for the seedpoints of each cluster includes discarding candidate representatives that do not respond to messages.

32. A method according to claim 28, wherein selecting a representative for the seedpoints of each cluster includes discarding candidate representatives that respond to messages with high variability.

33. A method according to claim 32, wherein thresholds are employed in ascertaining higher-than-acceptable variability, each threshold being associated with a corresponding source of network traffic.

34. A method according to claim 28, wherein the representatives are used by an intelligent route controller to select paths for traffic to the destinations, the intelligent route controller being operative to (1) perform periodic measurements to each of the representatives via different connections of the intelligent route controller, and (2) on the basis of the periodic measurements to the representatives, conditionally modify which of the connections is used for traffic sent to the network destinations.

35. A method according to claim 1, wherein the initial grouping of network addresses is established by a set of address prefixes.

36. A method according to claim 35, wherein the address prefixes are also employed to establish closeness in the generalizing step.

37. A method according to claim 35, wherein the address prefixes reside in a routing table.

38. A method of clustering a plurality of network destinations having addresses spanned by a set of address prefixes, comprising:
identifying a plurality of seedpoints from among the network destinations, each seedpoint being an active one of the destinations associated with a corresponding at least one of the address prefixes;
topologically clustering the seedpoints into groups of topologically similar seedpoints;
performing a measurement from a predetermined location to a seedpoint within each group of seedpoints;
clustering the seedpoints into clusters based on the measurements, the clusters being selected in a manner achieving a desired trade-off between the number of clusters and the similarity among the measurements for the seedpoints within each cluster;
generalizing the clusters based on the address prefixes, the generalizing including conditionally modifying the set of address prefixes such that each address prefix in the conditionally modified set of address prefixes is associated with a corresponding single one of the clusters.

39. A method according to claim 38, wherein the density of the seedpoints in different address prefixes is varied based upon traffic statistics.

40. A method according to claim 38, wherein generalizing the clusters includes associating each seedpoint with the longest one of those address prefixes matching the seedpoint.

41. A method according to claim 38, wherein generalizing the clusters results in associating multiple address prefixes with each of at least some of the clusters.

42. A method according to claim 38, wherein conditionally modifying the set of address prefixes comprises recursively splitting each address prefix that matches seedpoints from multiple clusters until each resulting address prefix matches seedpoints from only one cluster.

43. A method according to claim 38, wherein conditionally modifying the set of address prefixes comprises recursively merging address prefixes having greater granularity than the address prefixes in the set of address prefixes until any further merging would result in associating at least one address prefix with seedpoints of multiple clusters.

44. A method according to claim 38, further comprising for each cluster, selecting a representative having a predetermined relationship to the seedpoints of the cluster, and associating the representative with each address prefix associated with the cluster in the conditionally modified set of address prefixes.

45. A method according to claim 44, wherein the predetermined relationship of each representative to the seedpoints of the associated cluster is a predetermined relationship of the representative to a centroid of the seedpoints.

46. A method according to claim 44, wherein the predetermined relationship of each representative to the seedpoints of the associated cluster comprises lying along a network path to a selected one of the seedpoints.

47. A method according to claim 44, wherein selecting a representative for the seedpoints of each cluster includes discarding candidate representatives that do no respond to messages.

48. A method according to claim 44, wherein selecting a representative for the seedpoints of each cluster includes discarding candidate representatives that respond to messages with high variability.

49. A method according to claim 48, wherein thresholds are employed in ascertaining higher-than-acceptable variability, each threshold being associated with a corresponding source of network traffic.

50. A method according to claim 44, wherein the representatives are used by an intelligent route controller to select paths for traffic to the destinations, the intelligent route controller being operative to (1) perform periodic measurements to each of the representatives via different connections of the intelligent route controller, and (2) on the basis of the periodic measurements to the representatives, conditionally modify which of the connections is used for traffic sent to the network destinations.
